(19) United States
(12) Patent Application Publication
(10) Pub. No.: US 2007/0079230 A1
(43) Pub. Date: Apr. 5, 2007

(54) Table column navigation

(75) Inventor: Peter Vignet, San Francisco, CA (US)

Correspondence Address: HOLLAND & KNIGHT, LLP, 10 ST. JAMES AVENUE, BOSTON, MA, 02116, US

(73) Assignee: SAP AG, Walldorf (DE)

(21) Appl. No.: 11/243,156

(22) Filed: Oct. 4, 2005

(51) Int. Cl. G06F 17/00

(52) U.S. Cl. 715/504; 715/818

(57) ABSTRACT

Methods and apparatus, including computer program products, for table columns navigation. A computer-implemented method of displaying information on a computer display device includes loading data into a memory, displaying a first view of a table user interface (UI) on the display device, the first view including column navigation functions and a first subset of the data arranged in rows and columns, and generating a second view of the table UI in response to activation of a selected column navigation function, the second view including a second subset of the data arranged in rows and columns

### BACKGROUND

The present invention relates to data processing by digital computer, and more particularly to table column navigation.

User interfaces (UIs) are an integral part of many business enterprise software applications. For example, Web Dynpro from SAP AG enables companies to model and design UIs cost-effectively and precisely. A Web Dynpro application includes a set of views, navigation between the views, concepts for managing the views and determining their sequence, a context for keeping session data, and the business logic of the application.

One type of UI element, a table UI, provides for the two-dimensional display of data in cells arranged into rows and columns. Often the table UI includes pushbuttons to enable rows navigation.

A Web Dynpro table UI element provides for the two-dimension display of data in cells arranged in rows and columns.

### SUMMARY

The present invention provides methods and apparatus, including computer program products, for table column navigation.

In general, in one aspect, the invention features a computer-implemented method of displaying information on a computer display device, the method including loading data into a memory, displaying a first view of a table user interface (UI) on the display device, the first view including column navigation functions and a first subset of the data arranged in rows and columns, and generating a second view of the table UI in response to activation of a selected column navigation function, the second view including a second subset of the data arranged in rows and columns.

In embodiments, loading into to the memory can be by a single call to a back end system. The column navigation functions can include a first column function, a one span left function, a one column left function, a one column right function, a one span right function, and a last column function.

The one span left function can include shifting left the data arranged in rows and columns in the first view by a single period equivalent to a span. The one span right function can include shifting right the data arranged in rows and columns in the first view by a single period equivalent to a span.

The one column left function can include shifting left the data arranged in rows and columns in the first view by a single column. The one column right function can include shifting right the data arranged in rows and columns in the first view by a single column.

The invention can be implemented to realize one or more of the following advantages.

Column navigation within a table user interface (UI) is simple and quick and keeps track of, and manages, the visibility of columns where there can be much more data that is capable of display and any one time. Column navigation can be used with large tables with many columns and only one back end system call to load the appropriate data.

Column navigation enables easy data entry, an interactive aid for data analysis and flexibility to represent a table of data.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary system.

FIG. 2 is a block diagram of an exemplary table.

FIG. 3 is a block diagram of an exemplary table.

FIG. 4 is a block diagram of an exemplary table.

FIG. 5 is a block diagram of an exemplary table.

FIG. 6 is a block diagram of an exemplary table.

FIG. 7 is a flow diagram.

Like reference numbers and designations in the various drawings indicate like

### DETAILED DESCRIPTION

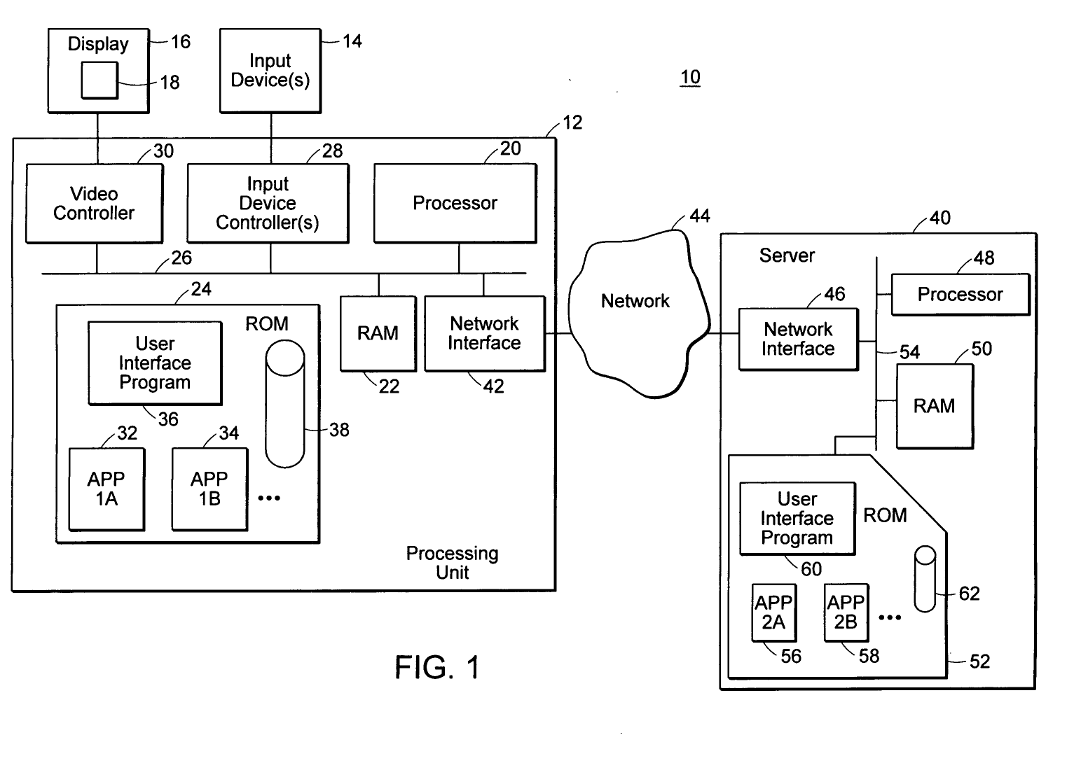

As shown in FIG. 1, an exemplary computer system 10 includes a processing unit 12, one or more input devices 14, and a display device 16, upon which a user is presented displays. The display device 16 has a video screen 18 upon which displays appear.

The processing unit 12 can include a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The system 10 is not limited to a personal computer (PC), but could include a personal digital assistant (PDA), a terminal, a workstation, or other such device.

ROM 24 provides non-volatile data storage for various application programs. In the example shown, a number of different application programs 32, 34, are stored in ROM 24. Also stored in ROM 24 is a user interface (UI) program 36 designed to work in concert with each of the application programs 32, 34. This is conceptually depicted by the UI program 36 shown as a layer on top of the application programs 32, 34. With such a design, UI program modules common to several application programs need not be duplicated in each of the application programs 32, 34. In addition, such a design may enable a common “look-and-feel” to the UI for the different program applications 32, 34. In other examples, the UI program, or module, is not a common program or module for more than one program application. In still other examples, the components described can be combined or separated in various manners, and can be stored in various manners, such as on various non-volatile storage medium.

Programs 32, 34, 36 have program instructions that can be loaded into RAM 22 during operation. Processor 20 then executes the program instructions, as required, to perform desired program functions.

Also stored in ROM 24 are various data in database 38. Database 38 includes data needed or generated during operation of the application programs 32, 34. Although only a single database 38 is shown that serves as a common database for all applications 32, 34, in other examples there can be separate databases for one, or more, of the applications 32, 34.

System 10 includes connection to a server 40 and a network interface 42, connected to its data bus 26. As such, system 10 can access server 40 over network 44 to run applications residing on the server 40. Network 44 can be, for example, a Local Area Network (LAN), Wide Area Network (WAN), or the Internet.

The server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, as well as a common user interface program 60 for the application programs 56, 58. ROM 52, in this example, includes data stored in database 62, although in other implementations separate databases or a separate database server may be required.

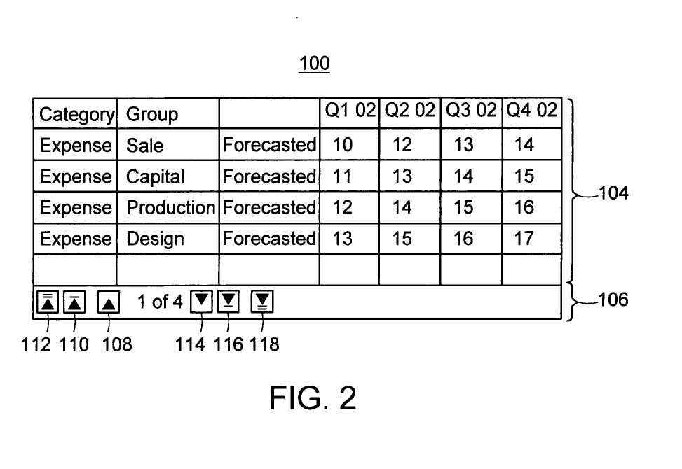

As shown in FIG. 2, an exemplary Web Dynpro table UI 100 includes table elements 104 and scroll bar functions 106. The Web Dynpro table UI 100 allows the two-dimensional display of data in cells arranged into rows and columns, i.e., table elements 104. Pushbuttons 106 provided in the footer of the table allow rows navigation.

The scroll bar functions 106 include first page 108, last page 110, page up 112, page down 114, line up 116 and line down 118. No column navigation is included.

The table UI 100 shows data for one year only (year 2002). A user may want to see more that one year at the time in the table UI 100.

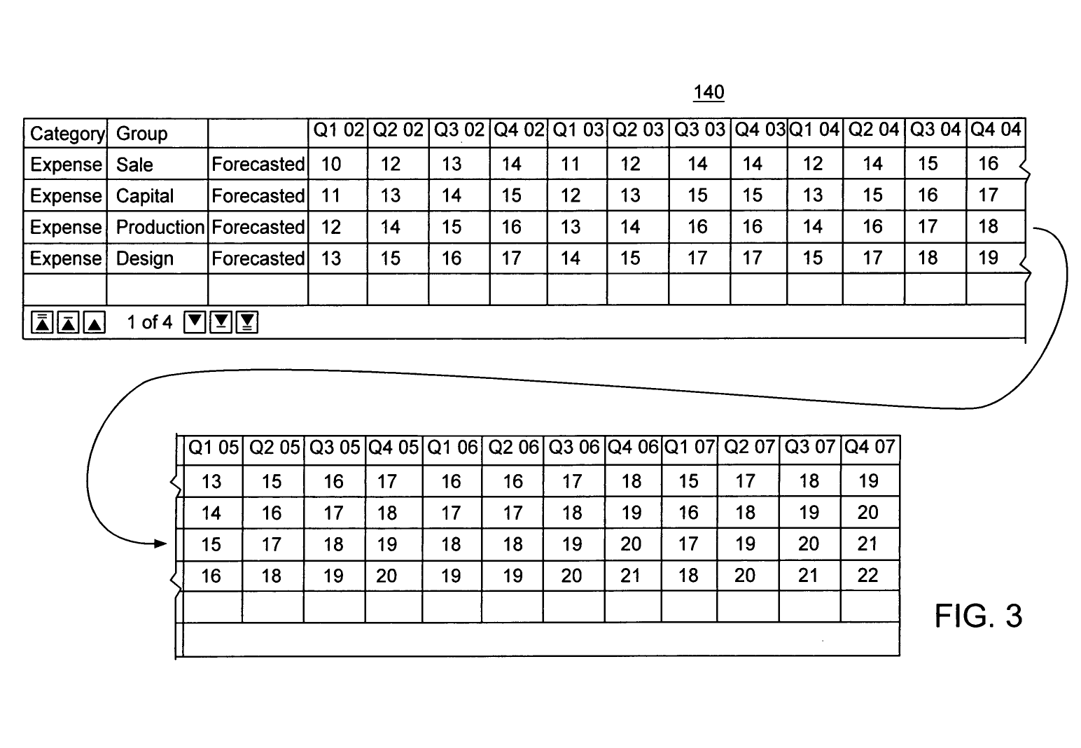

As shown in FIG. 3, an exemplary table UI 140 shows data for six years. Table UI 140 has an advantage that only one back end system call is made, so performance is improved. A disadvantage is the size of the table UI 140. Table UI 140 cannot fit in a single portal pane without using a horizontal scrolling bar.

The user may also want to make data entry in the last column of Table UI 140 but want the first column to be next to the last column so he/she does not have to scroll back and forth for tracking the row where he/she wants to enter data. In other words, he/she would prefer a fixed first column. To avoid using a distracting scrolling bar the table UI 140 should include column navigation.

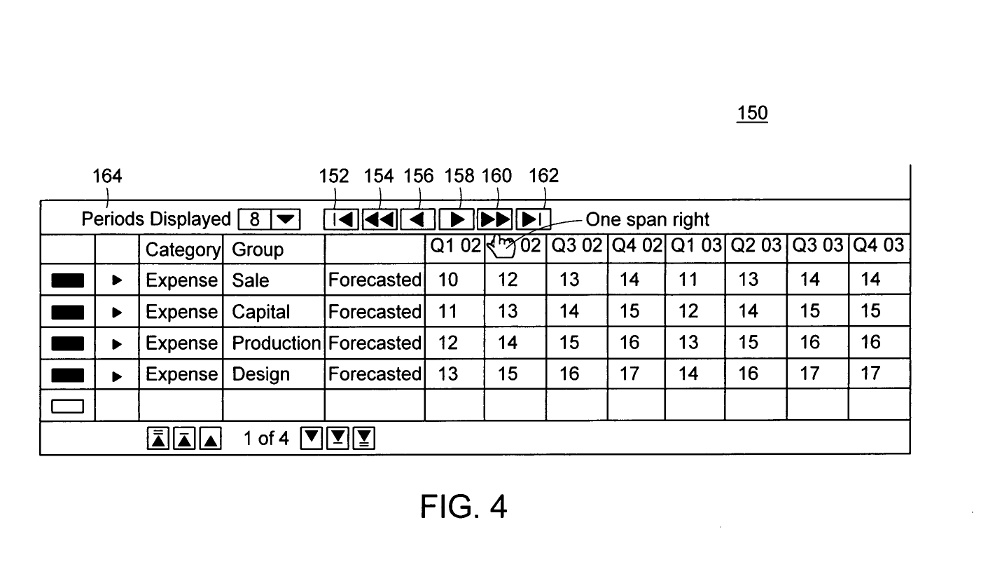

As shown in FIG. 4, a table UI 150 includes column navigator functions first column 152, one span left 154, one column left 156, one column right 158, one span right 160 and last column 162. The column navigator functions 152, 154, 156, 158, 160, 162 enable a user to control the visibility of each of the columns and make them visible or non-visible according to user requirements. Data representative of several years is populated from a call to a back end system, which cannot fit entirely on one screen, can be selectively displayed as the user requires. In this UI 150 there are eight columns shown as indicated by periods displayed 164. The eight columns shown results from Q1 02 to Q4 03, i.e., two years.

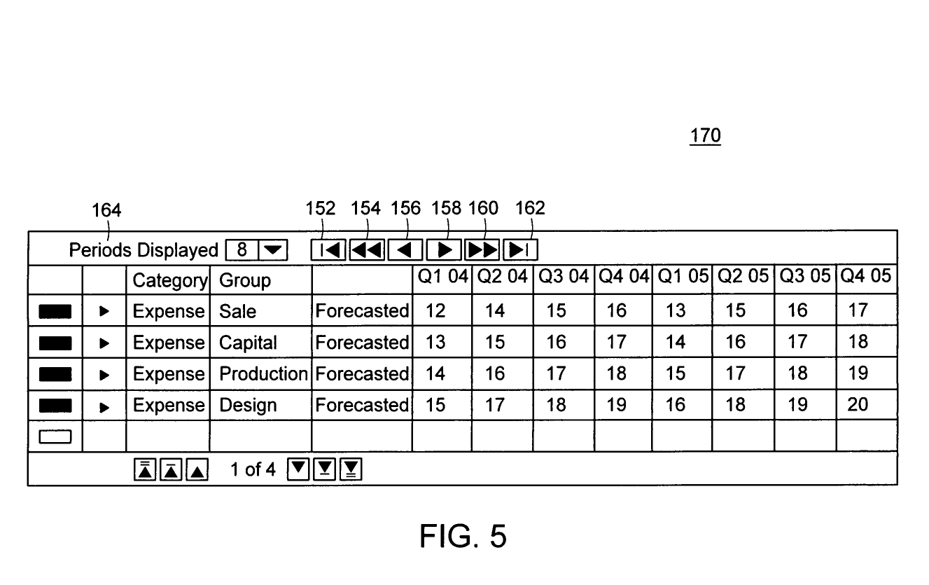

As shown in FIG. 5, a table UI 170 results after a user clicks on the one span right function 160. Table UI 170 now displays new columns shown from Q1 04 to Q4 05. Selecting the one span right function 160 replaced data representative of 2002 to 2003 with data representative of 2004 to 2005. In this table UI 170 there are eight columns shown as indicated by periods displayed 164.

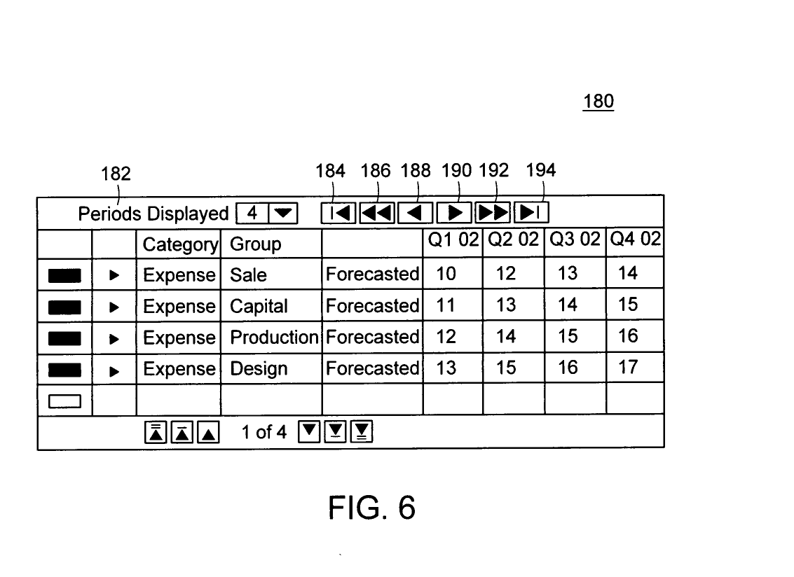

As shown in FIG. 6, a table UI 180 includes four periods displayed 182 in accordance with the user's requirements, although more years of data were loaded from a single call to the back end system. Table UI 180 includes column navigator functions first column 184, one span left 186, one column left 188, one column right 190, one span right 192 and last column 194. Here again, the column navigator functions 184, 186, 188, 190, 192, 195 enable the user to control the visibility of each of the columns and make them visible or non-visible according to user requirements.

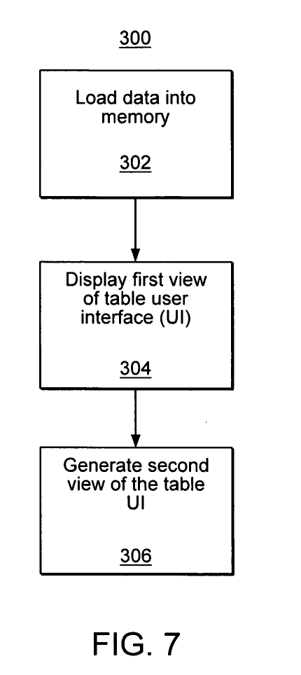

As shown in FIG. 7, a process 300 for displaying information on a computer display device includes loading (302) data into a memory. Process 300 displays (304) a first view of a table user interface (UI) on the display device, the first view including column navigation functions and a first subset of the data arranged in rows and columns. Process 300 generates (306) a second view of the table UI in response to activation of a selected column navigation function, the second view including a second subset of the data arranged in rows and columns.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method of displaying information on a computer display device, the method comprising:
loading data into a memory;
displaying a first view of a table user interface (UI) on the display device, the first view including column navigation functions and a first subset of the data arranged in rows and columns; and
generating a second view of the table UI in response to activation of a selected column navigation function, the second view including a second subset of the data arranged in rows and columns.

2. The computer-implemented method of claim 1 wherein loading comprises a single call to a back end system.

3. The computer-implemented method of claim 1 wherein the column navigation functions comprise a first column function.

4. The computer-implemented method of claim 1 wherein the column navigation functions comprise a one span left function.

5. The computer-implemented method of claim 4 wherein the one span left function comprises shifting left the data arranged in rows and columns in the first view by a single period equivalent to a span.

6. The computer-implemented method of claim 1 wherein the column navigation functions comprise a one column left function.

7. The computer-implemented method of claim 6 wherein the one column left function comprises shifting left the data arranged in rows and columns in the first view by a single column.

8. The computer-implemented method of claim 1 wherein the column navigation functions comprise a one column right function.

9. The computer-implemented method of claim 8 wherein the one column right function comprises shifting right the data arranged in rows and columns in the first view by a single column.

10. The computer-implemented method of claim 1 wherein the column navigation functions comprise a one span right function.

11. The computer-implemented method of claim 10 wherein the one span right function comprises shifting right the data arranged in rows and columns in the first view by a single period equivalent to a span.

12. The computer-implemented method of claim 1 wherein the column navigation functions comprise a last column function.

13. A computer program product, tangibly embodied in an information carrier, for displaying information on a computer display device, the computer program product being operable to cause data processing apparatus to:
load data into a memory;
display a first view of a table user interface (UI) on the display device, the first view including column navigation functions and a first subset of the data arranged in rows and columns; and
generate a second view of the table UI in response to activation of a selected column navigation function, the second view including a second subset of the data arranged in rows and columns.

14. The program product of claim 13 wherein loading comprises a single call to a back end system.

15. The program product of claim 13 wherein the column navigation functions are selected from the group consisting of a first column function, a one span left function, a one column left function, a one column right function, a one span right function, and a last column function.

16. The program product of claim 15 wherein the one span left function comprises shifting left the data arranged in rows and columns in the first view by a single period equivalent to a span.

17. The program product of claim 15 wherein the one column left function comprises shifting left the data arranged in rows and columns in the first view by a single column.

18. The program product of claim 15 wherein the one column right function comprises shifting right the data arranged in rows and columns in the first view by a single column.

19. The program product of claim 15 wherein the one span right function comprises shifting right the data arranged in rows and columns in the first view by a single period equivalent to a span.
